(19) United States
(12) Patent Application Publication
(10) Pub. No.: US 2006/0028668 A1
(43) Pub. Date: Feb. 9, 2006

(54) Information processor, a printing method, a printing program, a printing information generating program, and a recording medium

(76) Inventor: Hiroya Kumashio, Kanagawa (JP)

Correspondence Address: DICKSTEIN SHAPIRO MORIN & OSHINSKY LLP, 2101 L Street, NW, Washington, DC, 20037, US

(21) Appl. No.: 11/190,125

(22) Filed: Jul. 27, 2005

(30) Foreign Application Priority Data
Aug. 3, 2004 (JP) 2004-226950

(51) Int. Cl. G06F 3/12

(52) U.S. Cl. 358/1.13; 358/1.15

(57) ABSTRACT

An information processor that causes a printer connected through a network to print information generated by an application is disclosed. The information processor includes a setting management unit for defining a plurality of presets, each including a setup of a plurality of printing functions specified when printing by the printer, and for managing the presets one by one, and a setup information providing unit for providing the application with setup information selected by the application, the setup information including the setup of the printing functions managed as the preset by the setting management unit, wherein the printer prints the information generated by the application based on the setup of the printing functions according to the preset selected by the application.

### BACKGROUND OF THE INVENTION

1. Field of the Invention

The present invention generally relates to an information processor, a printing method, a printing program, a printing information generating program, and a recording medium; and especially relates to an information processor, a printing method, a printing program, a printing information generating program, and a recording medium for performing printing by a printing machine, such as a printer.

2. Description of the Related Art

With printers offering multi-functions in recent years and continuing, versatile printing functions are available when printing, such as intensive printing, double-sided printing, staple processing, and punch processing. While the printing functions, such as above, provide versatile printing options, setting up a printing function is complicated. Fortunately, a technology that simplifies such setup of the printing function when printing is already available, wherein a setup of two or more printing functions is beforehand registered, and the registered setup is called at the time of printing (for example, Patent Reference 1).

[Patent Reference 1]

JPA 2002-182871

[Problem(s) to be Solved by the Invention]

However, in order to use the function according to Patent Reference 1, when performing printing from an application, a printing dialog has to be displayed, a printer property dialog has to be displayed by pushing a property button on the printing dialog, and then a setup beforehand registered has to be selected, which is a problem to be solved by the present invention.

### SUMMARY OF THE INVENTION

The present invention is made in view of the above-described problem, and aims at offering an information processor, a printing method, a printing program, a printing information generating program, and a recording medium that can mitigate the work burden of setting up a printing function at the time of printing, substantially obviating one or more of the problems caused by the limitations and disadvantages of the related art.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by an information processor, a printing method, a printing program, a printing information generating program, and a recording medium particularly pointed out in the specification in such full, clear, concise, and exact terms as to enable a person having ordinary skill in the art to practice the invention.

[Unit for Solving the Problem]

To achieve these and other advantages and in accordance with the purpose of the invention, as embodied and broadly described herein, the invention provides an information processor that causes a printer connected through a network to print information generated by an application, the information processor including

a setting management unit that manages a plurality of presets each including a setup of two or more printing functions specified when printing, and manages the presets one by one, and

a setup information providing unit that provides the application with setup information in response to a request from the application, the setup information corresponding to the setup of the printing functions managed as the corresponding preset by the setting management unit,

such that information generated by the application is printed by the printer based on the setup selected by the application.

Since the information processor described as above is capable of providing the application with the setup information corresponding to each preset, an operational item (a menu item, a button, etc.) can be provided to the preset, the application can display the operational item, and the work burden of setting up printing functions at the time of printing is mitigated by the application.

Further, in order to solve the problem, the present invention can be served by a printing method of the information processor, a program for the information processor to carry out the printing method, and a recording medium that stores the program.

[Effect of the Invention]

The work burden of the printing function setup at the time of printing is mitigated by the information processor, the printing method, the printing program, the printing information generating program, and the recording medium according to the present invention.

### BRIEF DESCRIPTION OF THE DRAWINGS

FIG. 1 is a block diagram showing a structure example of a printing system according to an embodiment of the present invention;

FIG. 2 is a screen image for explaining an example of using a preset;

FIG. 3 is a table showing contents of a preset that is managed by a preset setting management unit according to the first embodiment;

FIG. 4 is a table for explaining functions stored as a driver API according to the first embodiment;

FIG. 5 is a block diagram showing an example of hardware configuration of an information processor according to the embodiment of the present invention;

FIG. 6 is a flowchart showing a process when starting an application according to the first embodiment of the present invention;

FIG. 7 is a screen image showing an example of a tool bar of an application screen;

FIG. 8 is a screen image showing an example of a menu of the application screen;

FIG. 9 is a flowchart for explaining a process at the time of printing according to the first embodiment of the present invention;

FIG. 10 is a table showing contents of a preset that is managed by the preset setting management unit according to the second embodiment;

FIG. 11 is a table for explaining functions stored as the driver API according to the second embodiment;

FIG. 12 is a flowchart showing a process when starting an application according to the second embodiment of the present invention;

FIG. 13 is a flowchart for explaining a process at the time of printing according to the second embodiment of the present invention.

### DESCRIPTION OF THE PREFERRED EMBODIMENTS

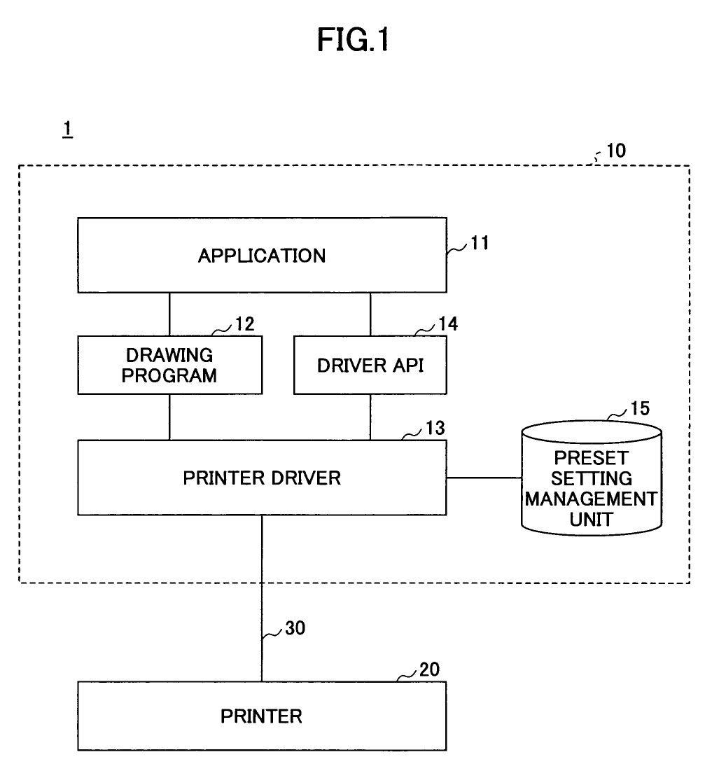

In the following, embodiments of the present invention are described with reference to the accompanying drawings. FIG. 1 is a block diagram showing an example configuration of a printing system 1 according to the embodiment of the present invention. The printing system 1 includes an information processor 10, a printer 20, and a network 30 such as a LAN that may be either a wired network or a wireless network, or a combination thereof. The information processor 10 and the printer are connected via the network 30.

The printer 20 is for printing data that the information processor 10 requests to print.

The information processor 10 is a terminal such as a PC (Personal Computer), a PDA (Personal Digital (Data) Assistant), and a cellular phone with which a user generates document data. The information processor 10 includes an application 11, a drawing program 12, a printer driver 13, a driver API 14, a preset setting management unit 15, and so on that are necessary for generating and printing the document data, etc.

Examples of the application 11 include word processing software and spreadsheet software for generating information such as document data for printing by the printer 20. The drawing program 12 is a module that provides the application 11 with a functional interface for drawing and for absorbing (bridging) the differences between devices, such as the printer and a display. When a printing command is issued, the application 11 converts the document data that are specific to the application 11 (application-dependent data) into application-independent data by calling various functions of the drawing program 12. An example of the drawing program 12 is GDI (Graphics Device Interface) in the Windows (registered trademark) environment.

The printer driver 13 is a module that converts the application-independent data output by the drawing program 12 into printing data in a format that can be interpreted by a printer (such as the printer 20) that the printer driver 13 drives. Although the printer driver 13 is represented by a box in FIG. 1, this is not intended to mean that only one printer driver can be installed to the information processor 10. Rather, the printer driver 13 in FIG. 1 abstractly represents one or more printer drivers.

According to the embodiment, a setup of each of the printing functions of the printer 20 specified at the time of printing can be beforehand registered in the printer driver 13 as one setup (preset). Here, the printing functions include intensive printing, double-sided printing, staple processing, and punch processing. In this manner, a user does not have to set up each printing function at the time of printing, but can select a preset corresponding to a desired setup of the printing functions, and carry out printing with the desired setup.

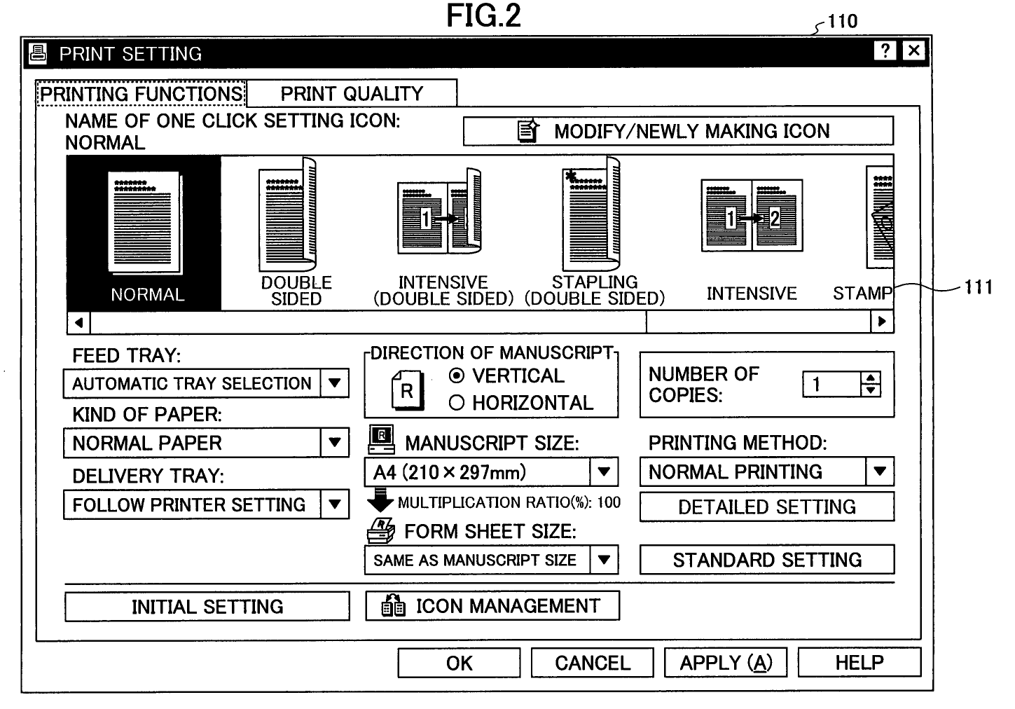

An example of using the preset is described with reference to FIG. 2. FIG. 2 shows a printer property dialog 110 that is displayed by the printer driver 13 when a “Property” button is clicked in a printing dialog, which is displayed when printing of document data is directed by the application 11. Each icon displayed at an icon display area 111 of the printer property dialog 110 corresponds to one preset, and visually expresses a setup of the printing function pertaining to the preset. Accordingly, the user can use a preset corresponding to an icon, i.e., a setup of a printing function, by selecting the icon in the icon display area 111. In addition, in the printer property dialog 110, it is also possible to set up other printing options, for example, a feed tray, a form kind, a delivery tray, the direction of a manuscript, a manuscript size, a paper size, the number of copies to print, and a printing method.

With reference to FIG. 1, contents of each preset are registered in the preset setting management unit 15. The preset setting management unit 15 is provided to each of the printer drivers 13. Therefore, when a specific printer driver 13 displays the printer property dialog 110, the specific printer driver 13 acquires the contents of a preset for the specific printer driver 13 from the preset setting management unit 15.

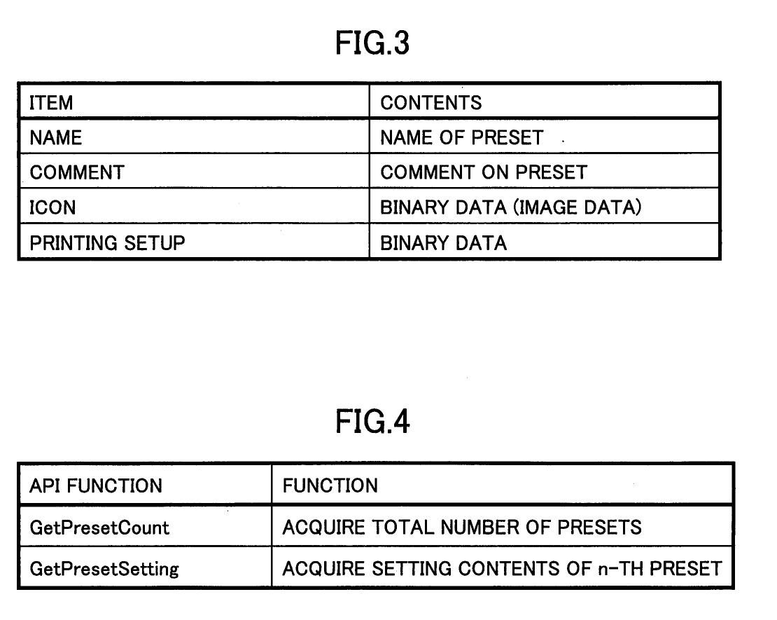

FIG. 3 is a table showing the setting contents of one preset stored in the preset setting management unit 15 according to the first embodiment. Each preset consists of items, such as a name, a comment, an icon, and a printing setup. The name is a character string for identifying each preset. The comment is an explanatory note of the contents of the preset. The icon is binary data of an icon to be displayed at the icon display area 111 of the printer property dialog 110 described above in order to identify the preset. The printing setup is binary data representing a setup of two or more printing functions registered as the preset, for example, a DEVMODE structure of Windows (registered trademark).

The driver API (Application Program Interface) 14 is a module containing a group of functions for providing information about the preset of the printer driver 13 to an external application (in this example, the application 11), the module being connected to each printer driver 13.

FIG. 4 is a table for explaining the functions provided by the driver API 14 according to the first embodiment. As shown in FIG. 4, a “GetPresetCount” function and a “GetPresetSetting” function are provided by the driver API 14. The “GetPresetCount” function returns the total number of presets. The “GetPresetSetting” function returns the setting contents (FIG. 3) of a specified preset (for example, the n-th preset in turn). That is, the “GetPresetSetting” function requires an integer (n) as an input argument, and returns the setting contents of the nth preset in turn as specified by the input argument.

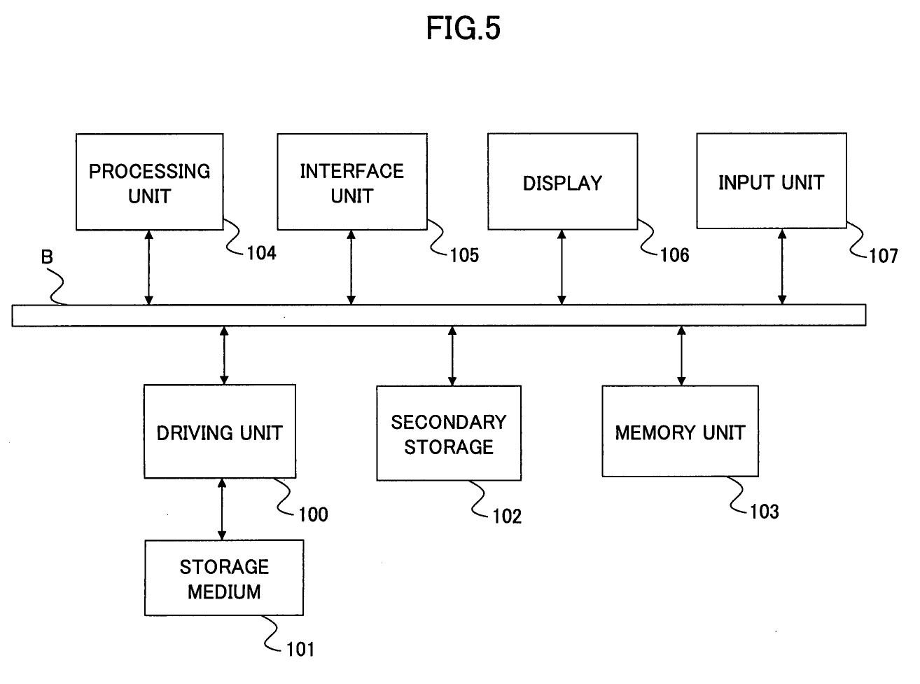

Next, the information processor 10 is described in detail. FIG. 5 is a block diagram showing an example of a hardware configuration of the information processor 10 according to the embodiment of the present invention. The information processor 10 of FIG. 5 includes a driving unit 100, a secondary storage 102, a memory unit 103, a processing unit 104, an interface unit 105, a display 106, and an input unit 107, all of which are mutually connected by a Bus B. Further, a storage medium 101 can be mounted in the driving unit 100.

A program that carries out a process of the information processor 10 is provided by the storage medium 101, such as a CD-ROM. When the storage medium 101 containing the program is loaded in the driving unit 100, a copy of the program is transferred to the secondary storage 102 through the driving unit 100 from the recording medium 101. The secondary storage 102 stores the transferred program, necessary files, data, etc.

When the program is started, the memory unit 103 holds a copy of the program transferred from the secondary storage 102. The processing unit 104 executes a function related to the information processor 10 according to the program held in the memory unit 103. The interface unit 105 includes a modem and a router, for example, such that the information processor 10 is connected to the network 30 shown in FIG. 1. The display 106 as a part of the GUI (Graphical User Interface) displays information provided by the program, etc. The input unit 107 consists of a keyboard, a mouse, etc., and it is used in order to input various operational directions.

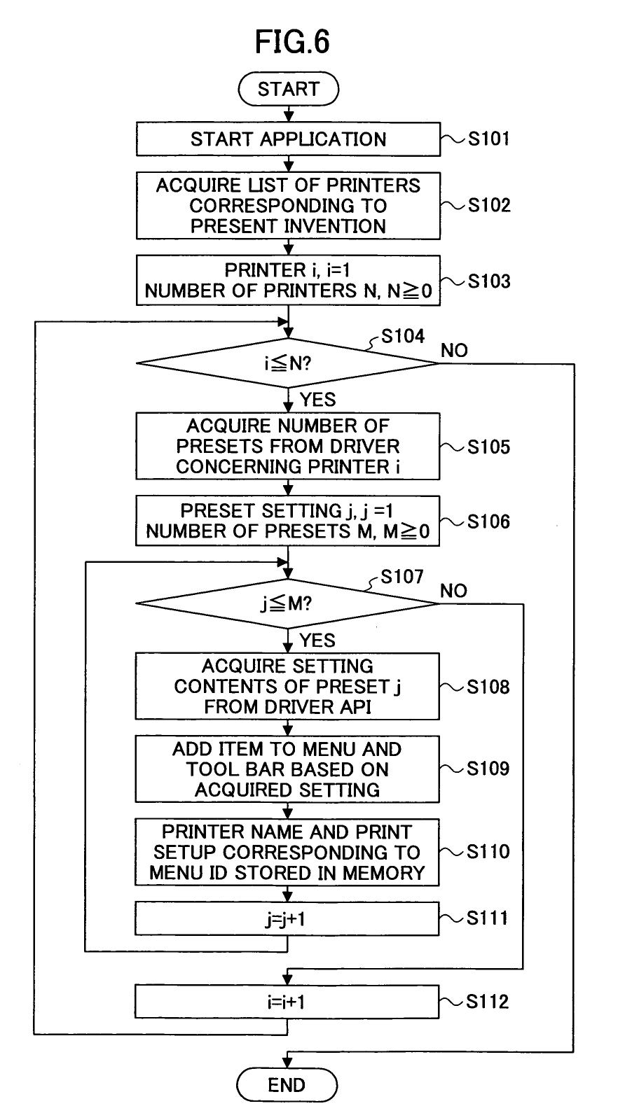

Hereafter, a process carried out by the information processor 10 of FIG. 1 is explained. FIG. 6 is a flowchart for explaining the process at the time of starting the application 11 according to the first embodiment.

When the application 11 is started by the information processor 10 (S101), the application 11 searches for and acquires a list of printer drivers 13, which printer drivers can register a preset (S102). Steps S103 and afterward constitute a loop process for each of the printer drivers 13 contained in the list of printer drivers 13. That is, the application 11 determines whether the process of all the printer drivers 13 is completed (S104). If there remains a printer driver 13 the processing of which has not been completed (YES at S104), a printer driver 13 in the list of printer drivers 13 is made a processing object (“current printer driver”), and the total number of presets of the current printer driver is acquired by calling the “GetPresetCount” function of the driver API 14 of the current printer driver 13 (S105). Here, in response to a call from the “GetPresetCount”, the current printer driver acquires the total number of presets by referring to the preset setting management unit 15, and returns the total number to the application 11.

Steps S106 through Step S111 constitute a loop process for each preset of the current printer driver. That is, the application 11 determines whether the processing is completed for all the presets (S107). If there remains a preset the processing of which has not been completed (YES at S107), setting contents (“current preset”) are acquired by calling the “GetPresetSetting” function of the driver API 14 of the current printer driver (S108). Here, in response to a call of the “GetPresetSetting” function, the current printer driver acquires the setting contents of the current preset from the preset setting management unit 15 of the current printer drive, and returns the setting contents to the application 11.

The application 11 adds (S109) operational items (e.g., a menu item, and a button of a tool bar) corresponding to each preset to the menu and the tool bar of a GUI screen (“application screen”) on which the application 11 is displayed based on the acquired setting contents. Identifiers (e.g., menu ID) corresponding to each of the operational items that are added, a name of the printer to which the current printer driver corresponds, and the setting contents of the current preset are associated, and held in the memory unit 103 (S110).

Then, Steps S107 through S110 are carried out for other presets, one by one, of the current printer driver (S111). Further, the process after Step S104 is also carried out for other printer drivers (S112), and an application screen 120 is displayed.

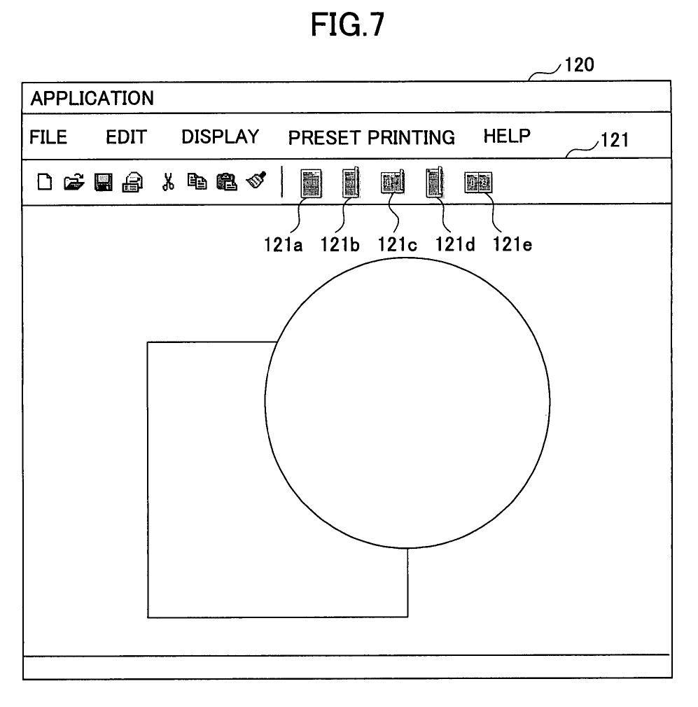

FIG. 7 shows an example of the display of a tool bar 121 of the application screen 120. As shown in FIG. 7, buttons 121a, 121b, 121c, 121d, and 121e corresponding to presets, each being different from the others, are shown in the tool bar 121 of the application screen 120 pursuant to the process at Step S109. At each of the buttons, corresponding icons of the presets are displayed so that the printing function corresponding to each preset can be easily recognized by the user.

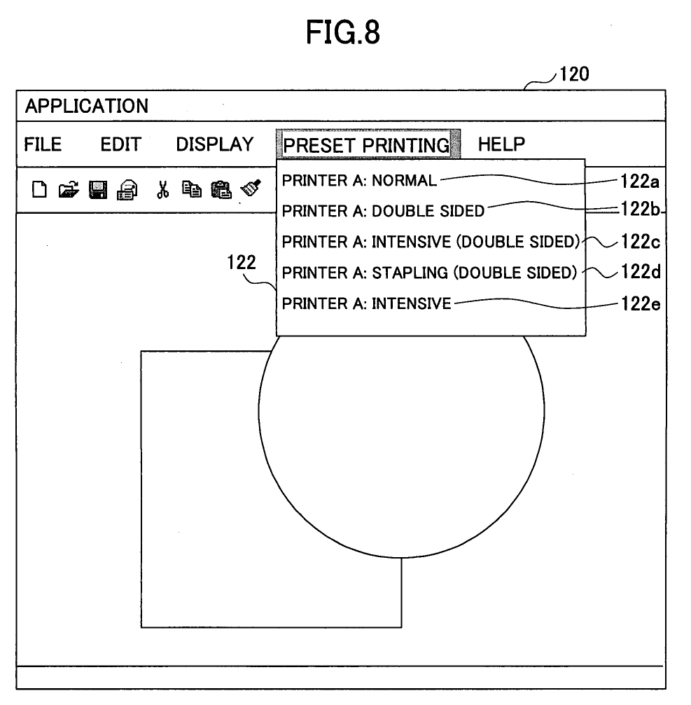

Furthermore, FIG. 8 shows an example of a menu displayed on the application screen 120. As shown in FIG. 8, when a preset printing menu 122 of the application screen 120 is opened, menu items 122a, 122b, 122c, 122d, and 122e are displayed, corresponding to presets, which are different from each other. The name of each preset concerned is displayed on the corresponding menu item so that the printing function of each preset can be recognized by the user.

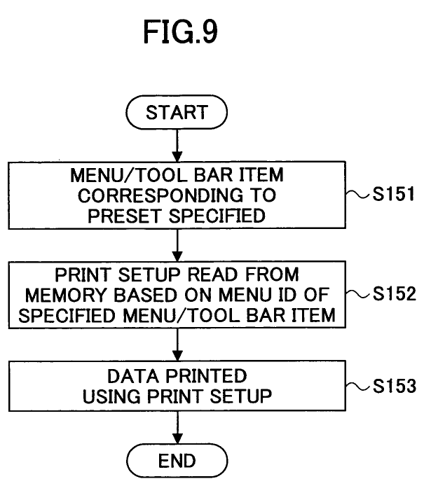

Next, a process is described, which process is performed when the user selects one of the buttons on the tool bar 121 and the menu items of the preset printing menu 122 of the application screen 120 such that the document data under editing are printed. FIG. 9 is a flowchart for explaining the process according to the first embodiment.

The user selects one of the buttons of the tool bar 121 and the menu items of the preset printing menu 122 (S151). Then, based on the ID (menu ID, etc.) of the selected operational item, the application 11 reads a printing setup that is held in the memory unit 103, the printing setup being associated with the ID (S152). Then, the application 11 performs printing by the printer 20 using the read printing setup (S153).

As described above, according to the information processor 10 of the first embodiment, since the printer driver 13 can provide external applications (e.g., the application 11) with the contents of the presets through the driver API 14, the application can provide a menu item, a button on a tool bar, etc. corresponding to a preset as a part of the user interface. If this application is used, the user can select a desired preset by selecting one of the buttons of the tool bar and menu items without opening the printer property dialog 110, facilitating the setup of the printing functions at the time of printing.

By the way, a printing setup that is preset in the printer driver 13 can be modified after once being registered. That is, a printing setup that is preset in the printer driver 13 may be modified as desired by other applications, etc., while operating the application 11. However, according to the first embodiment, the application 11 reads a printing setup that is preset into the memory unit 103 when starting, and performs printing using the printing setup read from the memory unit 103; accordingly, if the printing setup that is preset in the printer driver 13 is modified by other applications after starting of the application 11, printing by the application 11 may not be carried out as desired by the user of the application 11. In order cope with this situation, the second embodiment is provided as follows.

The configurations of the printing system 1 and the hardware of the information processor 10 of the first embodiment, shown by FIGS. 1 and 5, also apply to the second embodiment.

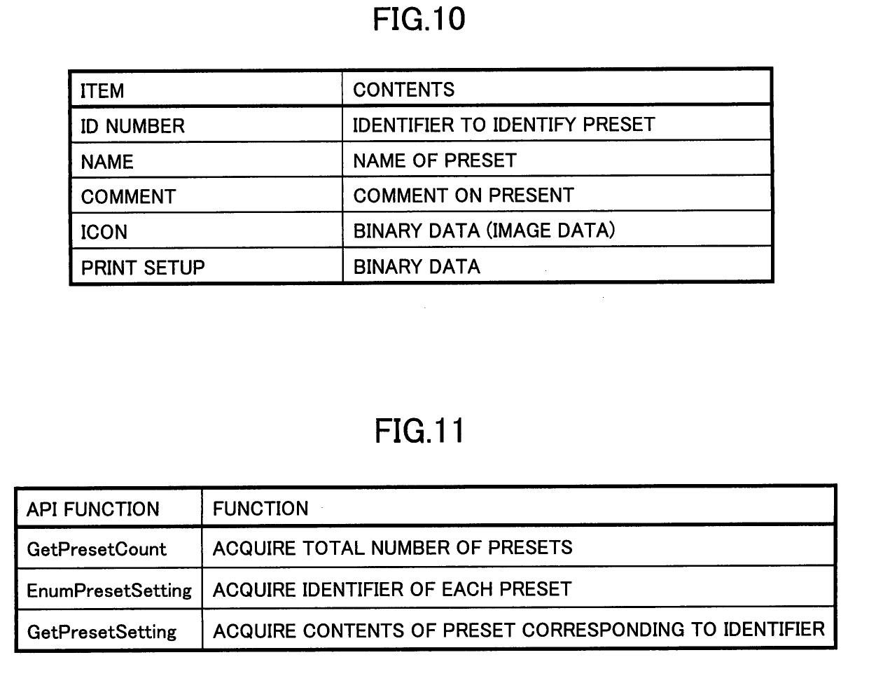

According to the printer driver 13 of the second embodiment, presets are managed by assigning an identifier, such as an identification number, to each preset. FIG. 10 is a table showing setting contents of a preset at the preset setting management unit 15 according to the second embodiment. As shown in FIG. 10, at the preset setting management unit 15 according to the second embodiment, the identification number is added as an item that uniquely identifies the preset. In this way, each preset can be identified by the identification number. In addition, once the identification number is set up, it is desirable that the identification number not be changed with an addition, a deletion, etc., of a preset.

FIG. 11 is a table showing functions of the driver API 14 according to the second embodiment. As shown in FIG. 11, an “EnumPresetSetting” function is newly included in the driver API 14 according to the second embodiment. The “EnumPresetSetting” function returns identifiers (for example, a matrix of the identification numbers) of all the presets available from the printer driver 13. Further, as for the “GetPresetSetting” function, the interface specification is changed. That is, the “GetPresetSetting” function according to the second embodiment requires not an integer that indicates the nth in turn (turn number) of a preset, but the identification number as an input argument, for returning the setting contents of a preset identified by the identification number.

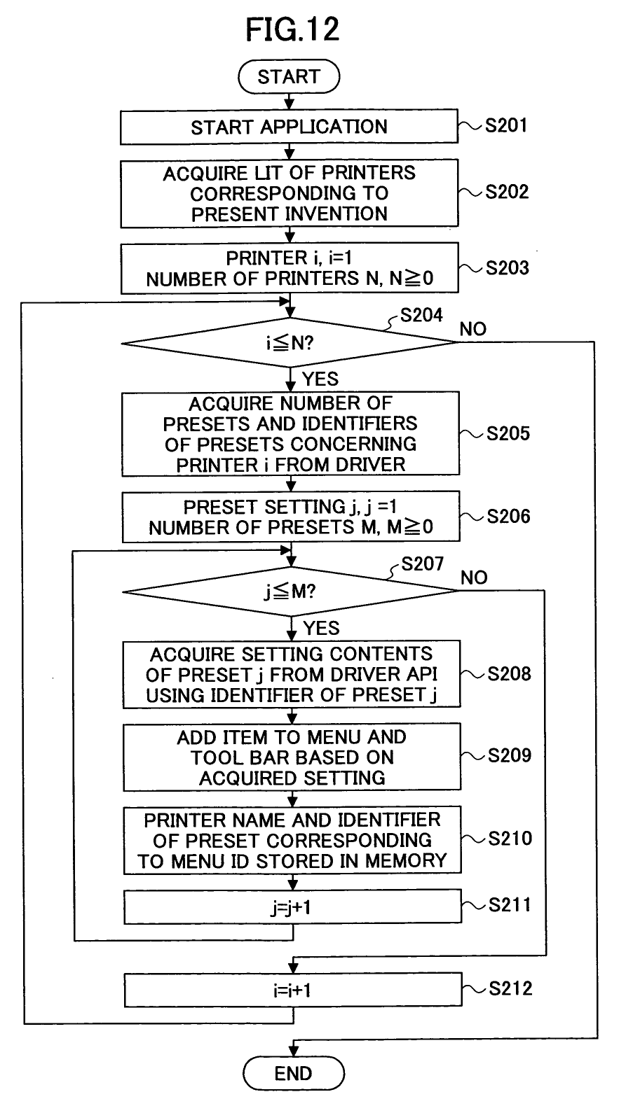

Hereafter, a process carried out by the information processor 10 according to the second embodiment is explained. FIG. 12 is a flowchart for explaining the process when the application is started according to the second embodiment.

The process shown in FIG. 12 is almost the same as that of the process shown in FIG. 6 of the first embodiment. Steps S201 through S212 in FIG. 12 correspond to Steps S101 through S212, respectively, in FIG. 6. However, since the identification number is used according to the second embodiment, not the nth number representing a turn, Steps S205, S208, and S210 are different from S105, S108, and S110, respectively. That is, at Step S205, the application 11 acquires the identification number of all the presets of the current printer driver by calling an “EnumPresetSetting” function while acquiring the total number of presets of the current printer driver by calling the “GetPresetCount” function of the driver API 14 of the current printer driver.

Further, when acquiring the setting contents of a preset at Step S208, the application 11 specifies the identification number acquired at Step S205 as the required argument, and calls the “GetPresetSetting” function. Furthermore, at Step S210, the application 11 sends the ID (menu ID, etc.) of each of the operational items (a menu item, a button of a tool bar, etc.) added to the application screen 120, the printer name of the printer to which the current printer driver corresponds, and the identification number of the current preset to the memory unit 103 to be held.

With the changes, the application 11 indirectly manages the setting contents of each preset using the identifiers, such as an identification number, rather than directly managing.

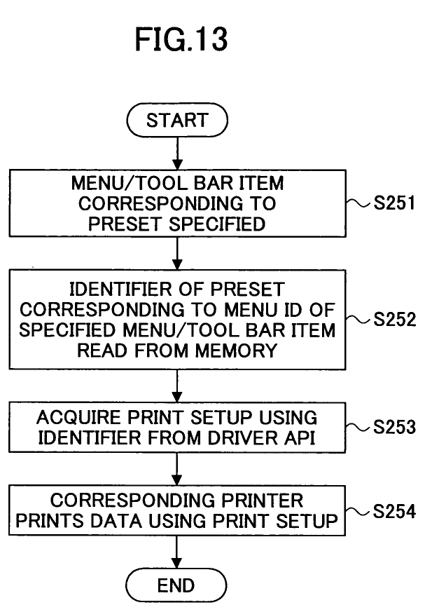

Next, a process of printing is described. FIG. 13 is a flowchart for explaining the printing process according to the second embodiment.

When the user selects an operational item represented by one of the menu items of the presetting printing menu 122 and the buttons of the tool bar 121 (S251), the application 11 reads an ID number of the preset (target preset) stored in association with the ID (menu ID, etc.) from the memory unit 103 based on the selected ID of the operational item (S252). The application 11 calls the “GetPresetSetting” function of the driver API 14, making the read identification number to be the required argument, and newly acquires the setting contents of the target preset from the printer driver 13 (S253). The application 11 performs printing with the printer 20 using the printing setup included in the setting contents that is newly acquired (S254).

As described above, according to the information processor 10 of the second embodiment, the application 11 can perform printing using the latest printing setup, even if the printing setup of the preset has been modified, by acquiring the latest printing setup of the preset based on the identifier when printing.

In addition, each preset can be identified not necessarily by the identifiers, such as identification numbers, but by a number representing the turn of each preset; and it is possible to arrange such that the latest setting contents of the existing preset are acquired by the application 11 based on the turn number at the time of printing. However, the turn number of each preset is subject to change when a new preset is added and when an existing preset is deleted; accordingly, it is more desirable that each preset be identified not by the turn number but by the identifier.

Further, the present invention is not limited to these embodiments, but variations and modifications may be made without departing from the scope of the present invention.

The present application is based on Japanese Priority Application No. 2004-226950 filed on Aug. 3, 2004 with the Japanese Patent Office, the entire contents of which are hereby incorporated by reference.

What is claimed is:

1. An information processor that causes a printer connected through a network to print information generated by an application, comprising:
a setting management unit for defining a plurality of presets, each of the presets including a setup of a plurality of printing functions specified when printing by the printer, and for managing the presets one by one; and
a setup information providing unit for providing the application with setup information in response to an inquiry from the application, the setup information including the setup of the printing functions managed as the corresponding preset by the setting management unit that manages the presets one by one; wherein
the printer prints the information generated by the application based on the setup of the printing functions according to the corresponding preset selected by the application.

2. The information processor as claimed in claim 1, wherein
the application displays an operational item for each of the setups based on the setup information of the corresponding preset acquired from the setup information providing unit, and
the printer prints the information generated by the application based on the setup of the printing functions defined by the preset corresponding to the operational item according to directions of the operational item.

3. The information processor as claimed in claim 2, wherein
the setting management unit manages at least one of an icon and a character string that represents the corresponding preset for each of the presets,
the setup information providing unit provides the application with at least one of the icon and the character string for each of the presets, and
the application displays the at least one of the icon and the character string as the operational item.

4. The information processor as claimed in claim 2, wherein the operational item is one of a menu item and a button.

5. The information processor as claimed in claim 2, wherein
the setting management unit manages identification information that identifies each of the presets,
the setup information providing unit provides the application with the identification information for each of the presets, and
the application acquires from the setup information providing unit the setup of the printing functions defined by the preset corresponding to the identification information that is associated with the operational item based on directions of the operational item, and
the information that is generated by the application is printed based on the acquired setup of the printing functions.

6. A printing method for an information processor that manages a plurality of presets, each of the presets defining a setup of a plurality of printing functions on a preset-to-preset basis, comprising:
a setup information providing step of providing an application with setup information for each of the presets that includes a setup of the printing functions managed on the preset-to-preset basis in response to an inquiry from the application that generates information to be printed, and
a printing step of printing the information generated by the application based on the setup of the printing functions defined by the preset selected by the application.

7. A printing program wherein a plurality of printing functions is made a preset, the printing functions being functions of a printer and specified when printing, and a plurality of the presets is managed on a preset-to-preset basis, comprising:
a setup information providing process of providing an application that generates information to be printed by the printer with setup information for each of the presets that includes a setup of the printing functions managed on the preset-to-preset basis in response to an inquiry from the application, and
a printing process of the printer printing the information generated by the application based on the setup of the printing functions defined by the preset selected by the application.

8. The printing program as claimed in claim 7, wherein the printing program is a printer driver.

9. A recording medium that stores the printing program as claimed in claim 7, the recording medium being computer-readable.

10. A printing information generating program for generating printing information, based on which a computer carries out printing by a printer, comprising:
a setup information acquisition process of acquiring setup information including a setup of a plurality of printing functions from a printer driver that manages a plurality of presets, each of the presets including a setup of the printing functions of the printer specified when printing on a preset-to-preset basis;
an operational item display process of displaying an operational item for each of the presets based on the setup information for the corresponding setup acquired by the setup information acquisition process; and
a printing process of printing information generated by the printing information generating program based on the setup of the printing functions included in the preset corresponding to the operational item according to directions of the operational item.

11. A recording medium that stores the printing information generating program as claimed in claim 10, the recording medium being computer-readable.
